(19) United States
(12) Patent Application Publication
(10) Pub. No.: US 2010/0115057 A1
(43) Pub. Date: May 6, 2010

(54) WEB SERVER SYSTEM AND METHOD FOR OPERATING WEB SERVER THEREOF

(75) Inventors: Chi-Yuan Kuan, Taipei City (TW); Ta-Hua Lin, Taipei City (TW); Chung-Nan Chen, Taipei City (TW)

Correspondence Address: J C PATENTS, 4 VENTURE, SUITE 250, IRVINE, CA, 92618, US

(73) Assignee: INVENTEC CORPORATION, Taipei City (TW)

(21) Appl. No.: 12/398,388

(22) Filed: Mar. 5, 2009

(30) Foreign Application Priority Data
Nov. 3, 2008 (TW) 97142381

(51) Int. Cl. G06F 15/16

(52) U.S. Cl. 709/219

(57) ABSTRACT

A web server system and a method for operating a web server thereof are provided. The method includes the following steps. A first browsing request issued by a remote apparatus is received, wherein the first browsing request records a web address of a first web page. It is determined that whether simplified browser information is recorded in a header of the first browsing request. A transformed address response is generated if the simplified browser information is recorded in the header of the first browsing request, and a header of the transformed address response records a web address of a second web page. The transformed address response triggers the remote apparatus to issue the second browsing request recording the web address of the second web page. The second web page is sent out according to the second browsing request recording the web address of the second web page.

### CROSS-REFERENCE TO RELATED APPLICATION

This application claims the priority benefit of Taiwan application serial no. 97142381, filed on Nov. 3, 2008. The entirety of the above-mentioned patent application is hereby incorporated by reference herein and made a part of this specification.

### BACKGROUND OF THE INVENTION

1. Field of the Invention

The present invention relates to a web server and more particularly, to a web server system and a method for operating a web server thereof.

2. Description of Related Art

In general, if a user accesses the Internet through a mobile device, web pages displayed thereon are the same as those displayed by a browser of a common computer system and thus may not be suitable for viewing by the user due to limited size and low resolution of the screen of the mobile device. Therefore, most manufacturers provide simplified web pages suitable for mobile devices so that users may easily view pages when using mobile devices to access the Internet. However, users have to enter a different web address from the address which the computer system signs onto a web server so as to use a web service suitable for mobile devices. For example, a web address that is entered when a common computer system is used to access the Internet is a web address of a web page having complex functionality while a web address that is entered when a mobile device is used to access the Internet is a web address of a web page having simplified functionality. This causes inconvenience in that the user has to save two different web addresses.

In light of the above, current technology provides a web page switch function. However, such switch is performed through scripts in remote devices in most cases. In other words, when a user goes on the Internet through a mobile device such as a cellular phone and enters a web address of a web page having complex functionality (i.e. a web address for use by a common computer system), the script program on the cellular phone will switch from the web page with the aforesaid web address to another web server address to download a web page suitable for a cellular phone though the web page switch function. However, browsers used on some mobile devices may not fully support the aforesaid script technology. Therefore, users still have to respectively save different web addresses in order to obtain optimum service.

### SUMMARY OF THE INVENTION

The present invention provides a web server system and a method for operating a web server thereof, which increases convenience in usage in that a user only has to save one web address whether he uses a common computer system or a mobile device to view web pages on the Internet.

The present invention provides a method for operating a web server. The method includes the following steps. First, a first browsing request issued by a remote apparatus is received, wherein the first browsing request records a web address of a first web page. Next, a determination is made on whether a header of the first browsing request records simplified browser information therein. If the simplified browser information is recorded in the header of the first browsing request, a transformed address response is generated and a header of the transformed address response records a web address of a second web page. The transformed address response triggers the remote apparatus to issue a second browsing request recording the web address of the second web page. Finally, the second web page is sent out according to the second browsing request recording the web address of the second web page.

In one embodiment of the present invention, the above method further includes the following steps. A determination is made on whether the first browsing request records the web address of the second web page. If the first browsing request records the web address of the second web page, the second web page is sent out according to the web address of the second web page.

In one embodiment of the present invention, the above method further includes the following steps. If the header of the first browsing request does not record the simplified browser information, the first web page is sent out according to the web address of the first web page.

In one embodiment of the present invention, the abovementioned transformed address response is a transformed address response of hypertext transfer protocol (HTTP).

The present invention provides a computer programming product stored in and used for operating a web server. When a computer loads and executes the computer program, the abovementioned method for operating a web server may be completed.

The present invention provides a computer readable recording medium with a program stored thereon. When the computer loads and executes the program, the abovementioned method for operating a web server may be completed.

The present invention provides a web server system including a remote apparatus and a web server. The remote apparatus issues a first browsing request which records a web address of a first web page. The web server receives the first browsing request and determines whether a header of the first browsing request records simplified browser information. If the simplified browser information is recorded in the header of the first browsing request, a transformed address response is generated for the remote apparatus and a header of the transformed address response records a web address of a second web page. The transformed address response may trigger the remote apparatus to issue a second browsing request recording the web address of the second web page. The web server sends the second web page to the remote apparatus according to the second browsing request recording the web address of the second web page.

The present invention decides whether to generate the transformed address response according to the determination on if the header of the browsing request records the simplified browser information and redirects the browser of the remote apparatus to a web address of a suitable web page. As such, the user only needs to save one web address whether he uses a common computer system or a mobile device to go online.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating the method for operating a web server according to an embodiment of the present invention.

FIG. 2 is schematic diagram illustrating a web server system and a communication protocol according to an embodiment of the present invention.

FIG. 3 is a flowchart illustrating the method for operating a web server according to another embodiment of the present invention.

### DESCRIPTION OF EMBODIMENTS

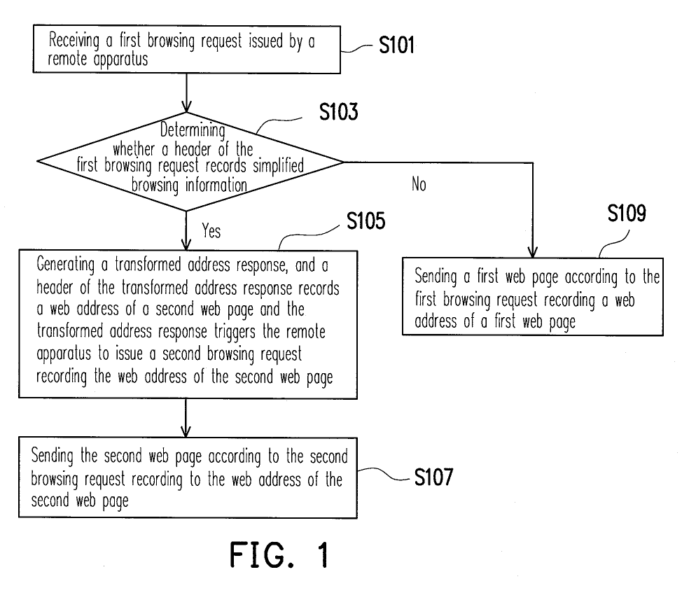

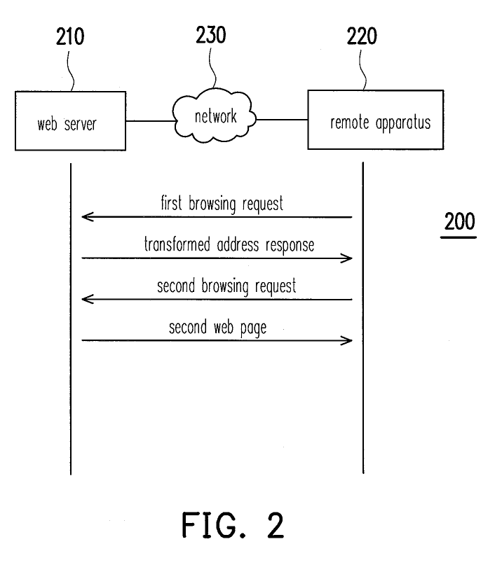

FIG. 1 is a flowchart illustrating the method for operating a web server according to an embodiment of the present invention. FIG. 2 is schematic diagram illustrating a web server system 200 and a communication protocol according to an embodiment of the present invention. In the present embodiment, a web server 210 operates in accordance with the hypertext transfer protocol (HTTP), for example, which is not to be limited herein. Referring to both FIG. 1 and FIG. 2, the web server system 200 includes the web server 210 and a remote apparatus 220. First, in step S101, the web server 210 receives a first browsing request issued by the remote apparatus 220 through a network 230, wherein the first browsing request records a web address of a first web page. The aforesaid web address of the first web page is hereby assumed to be a web address of a normal web page suitable for a browser of a common computer system (i.e. a web address of a web page having complex functionality). For example, the web address of the aforesaid normal web page is “http://xxx_entry/index.htm” and is recorded in a header of the first browsing request. For instance, in step S101, a user may use a common computer system or a mobile device (e.g. a cellular phone) to issue the aforesaid first browsing request to the web server 210.

Next, in step S103, the web server 210 determines whether the header of the first browsing request records simplified browser information. In the present embodiment, when the user issues the first browsing request through a simplified browser of a mobile device, the simplified browser records the simplified browser information in the header of the first browsing request. If the user issues the first browsing request through a browser of a common computer system, the header of the first browsing request records non-simplified browser information. For example, if the user issues the first browsing request through the browser Microsoft Internet Explorer (IE) 6.0, the browser will record “MSIE6.0” in a User-Agent field of the header of the first browsing request to indicate that the browser issuing the browsing request is Microsoft IE 6.0. As such, the web server 210 may find out what kind of device the user uses to issue the browsing request through the browser information recorded in the header of the browsing request.

Then, when it is determined that the header of the first browsing request records the simplified browser information (i.e. the user uses a mobile device to issue the first browsing request to the web server 210), step S105 is carried out in which the web server 210 generates a transformed address response recording a web address of a second web page in a header thereof and triggering the remote apparatus 220 to automatically issue a second browsing request recording the web address of the second web page. In the present embodiment, the web address of the second web page is a web address of a simplified web page suitable for a browser of a mobile device. For example, the web address of the aforesaid simplified web page is “http://Host/Mobile_Entry.htm” and is recorded in the header of the transformed address response. In addition to the web address of the second web page, the header of the transformed address response records a response code such as a status code 301 or 302 of HTTP. The aforesaid status codes 301 and 302 indicate that further operations are required at a user end to complete the request. In other words, when the user end (remote apparatus 220) receives the status code 301 or 302 generated by the web server 210, the user end has to again generate a new browsing request (i.e. the second browsing request) to the web server 210.

As described above, the transformed address response generated by the web server 210 is sent to the mobile device (the remote apparatus 220). When receiving the transformed address response, the browser of the mobile device finds the web address of the second web page in the header of the transformed address response according to the response code (status code 301 or 302) provided by the transformed address response. Then, the browser of the mobile device automatically issues the second browsing request which records the web address of the second web page in the header thereof. Furthermore, when the browser of the mobile device issues the second browsing request, the browser records the simplified browser information “Mobile Browser” in the User-Agent field of the header of the second browsing request to indicate that the browser which issues the browsing request is the browser of the mobile device.

Next, after the web server 210 has received the second browsing request issued by the remote apparatus 220, step S107 is carried out in which the web server 210 sends the second web page to the mobile device according to the second browsing request recording the web address of the second web page so that the browser of the mobile device may display the simplified web page. As such, the user dose not need to additionally save the web address of the simplified web page when using the mobile device to access the Internet. In the present embodiment, the web server sends a status code (e.g. a status code 200) in addition to the second web page to the mobile device. The aforesaid status code 200 represents that the second browsing request issued by the mobile device has been successful.

Continuing from the above step S103, when it is determined that the header of the first browsing request does not record the simplified browser information (i.e. the use may use a common computer system to issue the first browsing request to the web sever 210), step S109 is then carried out in which the web server 210 sends the first web page and the status code 200 to a browser of the computer system according to the first browsing request recording the web address of the first web page so that the normal web page is displayed for the user.

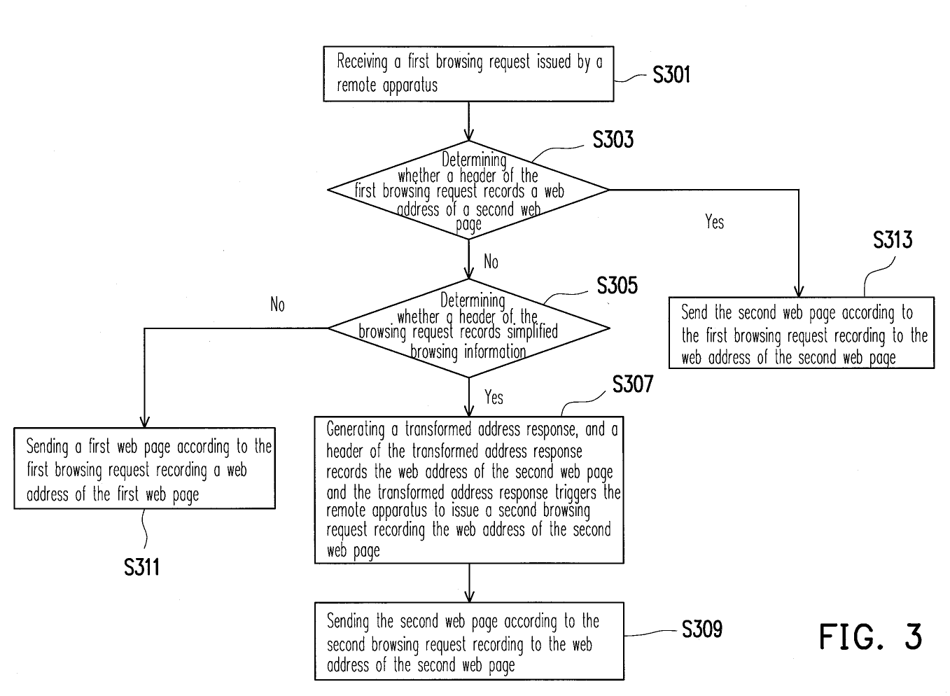

In order for those of ordinary skill in the art to better comprehend the method for operating the web server 210 of the present embodiment, another example is further illustrated below. FIG. 3 is a flowchart illustrating the method for operating a web server according to an embodiment of the present invention. For the purpose of illustration, assume the web address of the second web page is a web address of a simplified web page. In the present embodiment, the web server 210 operates in accordance with the hypertext transfer protocol (HTTP), for example, which is not to be limited herein.

Referring to both FIG. 2 and FIG. 3, first, in step S301, the web server 210 receives the first browsing request issued by the remote device 220 through the network 230. In the present embodiment, the user may issue the first browsing request by using a computer system or a mobile device and a web address entered by the user is a web address of a normal web page used for a browser of a common computer system. For example, the web address of the aforesaid normal web page is “http://xxx_entry/index.htm” and is recorded in the header of the first browsing request.

Next, in step S303, it is determined if the web address of the second web page (i.e. the web address of the simplified web page) is recorded in the first browsing request. The web address of the first web page is the web address of the normal web page. Therefore, in step S303, the web server 210 determines that the web address of the second web page is not recorded in the header of the first browsing request and thus step S305 is then carried out. In step S305, the web server 210 determines whether the header of the first browsing request records the simplified browser information. If the web server 210 determines that the simplified browser information is not recorded in the header of the first browsing request (i.e. the first browsing request is issued by a computer system), step S311 is then performed. In step S311, the web server 210 sends the first web page to the browser of the computer system (the remote apparatus 220) for the user to browse according to the first browsing request recording the web address of the first web page.

On the other hand, if the web server 210 determines, in step S305, that the simplified browser information is recorded in the header of the first browsing request, this indicates that the first browsing request is issued by a mobile device and thus step S307 is carried out to generate the transformed address response. Refer to the description of step S103 of FIG. 1 for illustration on step S305. The flow of operations of step S307 and step S309 are also in reference to step S105 and step S107 of FIG. 1, which are not further described herein.

In another embodiment, referring to FIG. 3 again, in step S301, if the user issues the first browsing request using a computer system or a mobile device (e.g. a cellular phone, a PDA, etc. . . . ) and the web address (i.e. the web address of the first web page) entered by the user is a web address of a simplified web page used by a browser suitable for a mobile device, The web address of the aforesaid simplified web page is “http://Host/Mobile_Entry.htm” and is recorded in the header of the first browsing request.

Next, in step S303, the web server 210 determines if the web address of the second web page (i.e. the web address of the simplified web page) is recorded in the header of the first browsing request. The web address of the first web page is the web address of the simplified web page (i.e. the web address of the first web page is the same as the web address of the second web page). Therefore, in step S303, the web server 210 determines that the header of the first browsing request records the web address of the second web page and then step S313 is carried out. In step S313, the web server 210 sends the second web page and the status code 200 to the browser of the computer system or the mobile device for the user to browse according to the first browsing request recording the web address of the second web page.

People of ordinary skill in the art may implement the abovementioned embodiments in any form according to the requirements. For example, the abovementioned embodiments may be realized by means of a computer readable storage medium with a program stored therein. In other words, the abovementioned embodiments may be implemented in the form of a program (computer software) and such a program is stored in a computer readable storage medium such as a hard disk, a floppy disk, or a CD-ROM. Due to the popularity of networks, the abovementioned program (computer software) may also be provided by means of direct transmission over a network in addition to being stored in a computer readable storage medium. In such case, the program is provided without storing the program in a storage medium. Therefore, people of ordinary skill in the art may implement the abovementioned embodiments in the form of a computer program product according to requirements. The computer program product refers to a computer readable program and is not limited to an object of physical form.

In summary, the present invention decides whether to generate the transformed address response according to the determination on if the header of the browsing request records the simplified browser information and redirects the browser of the remote apparatus to a web address of a suitable web page. As such, the user only needs to save one web address whether he uses a common computer system or a mobile device to go online.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for operating a web server, comprising:
receiving a first browsing request issued by a remote apparatus and recording a web address of a first web page;
determining whether a header of the first browsing request records simplified browser information;
generating a transformed address response if the header of the first browsing request records the simplified browser information, wherein a header of the transformed address response records a web address of a second web page and the transformed address response triggers the remote apparatus to issue a second browsing request recording the web address of the second web page; and
sending the second web page to the remote apparatus according to the second browsing request recording the web address of the second web page.

2. The method for operating a web server according to claim 1, further comprising:
determining whether the header of the first browsing request records the web address of the second web page; and
if the first browsing request records the web address of the second web page, sending the second web page to the remote apparatus according to the first browsing request recording the web address of the second web page.

3. The method for operating a web server according to claim 1, further comprising:
if the header of the first browsing request does not record the simplified browser information, sending the first web page to the remote apparatus according to the first browsing request recording the web address of the first web page.

4. The method for operating a web server according to claim 1, wherein the transformed address response is a transformed address response of hypertext transfer protocol (HTTP).

5. The method for operating a web server according to claim 1, wherein the step of determining whether the first browsing request records the simplified browser information is to check a User-Agent field in the header of the first browsing request to determine if the simplified browser information is recorded.

6. A computer program product with a program for operating a web server stored therein, wherein when a computer loads and executes the computer program, the method for operating a web server according to claim 1 can be completed.

7. A computer readable recording medium with a program stored therein, wherein when a computer loads and executes the program, the method for operating a web server according to claim 1 can be completed.

8. A web server system, comprising:
a remote apparatus, for issuing a first browsing request recording a web address of a first web page; and
a web server, for receiving the first browsing request, determining whether a header of the first browsing request records simplified browser information, and generating a transformed address response to the remote apparatus if the header of the first browsing request records the simplified browser information, wherein a header of the transformed address response records a web address of a second web page,
wherein the transformed address response triggers the remote apparatus to issue a second browsing request recording the web address of the second web page, and the web server sends the second web page to the remote apparatus according to the second browsing request recording the web address of the second web page.

9. The web server system according to claim 8, wherein the web server further determines whether the first browsing request records the web address of the second web page and sends the second web page to the remote apparatus according to the first browsing request if the first browsing request records the web address of the second web page.

10. The web server system according to claim 8, wherein the web server sends the first web page to the remote apparatus according to the web address of the first web page if the header of the first browsing request does not record the simplified browser information.

11. The method for operating a web server according to claim 8, wherein the transformed address response is a transformed address response of hypertext transfer protocol (HTTP).

12. The web server system according to claim 8, wherein the web server checks a User-Agent field in the header of the first browsing request to determine whether the first browsing request records the simplified browser information.

13. The web server system according to claim 8, wherein the remote apparatus is a mobile device.
